(19) United States
(12) Patent Application Publication
(10) Pub. No.: US 2019/0132893 A1
(43) Pub. Date: May 2, 2019

(54) UE-UE Configuration Framework w/o NW Support

(71) Applicant: Telefonaktiebolaget LM Ericsson (publ), Stockholm (SE)

(72) Inventors: Qianxi Lu, Beijing (CN); Shaohua Li, Beijing (CN); Xinghua Song, Beijing (CN); Stefano Sorrentino, Solna (SE); Pontus Wallentin, Linköping (SE)

(21) Appl. No.: 16/095,521

(22) PCT Filed: Apr. 20, 2016
(86) PCT No.: PCT/CN2016/079771

§ 371 Date: Oct. 22, 2018

(51) Int. Cl. H04W 76/14; H04L 12/24

(52) U.S. Cl. CPC H04W 76/14; H04W 88/04; H04L 41/0806

(57) ABSTRACT

This disclosure pertains to a method for operating a D2D device (10). The D2D device (10) is adapted for D2D communication. The method comprises transmitting a D2D coordination message to a second D2D device (10) and/or a network node. There are also disclosed related methods and devices.

### TECHNICAL FIELD

The present disclosure pertains to wireless communication technology, in particular to device-to-device (D2D) communication.

### BACKGROUND

D2D communication, which may also be referred to a sidelink communication or ProSe (Proximity Service) communication, in particular in the context of LTE, allows direct communication between devices like UEs (also referred to as D2D device in this context).

In particular, recent developments of the 3GPP Long Term Evolution (LTE) facilitate accessing local IP based services in the home, office, public hot spot or even outdoor environments. One of the important use cases for the local IP access and local connectivity involves the direct communication between devices in the close proximity (typically less than a few 10s of meters, but sometimes up to a few hundred meters) of each other.

This direct mode or device-to-device communication enables a number of potential gains over the traditional cellular technique, because D2D devices are much closer to one another than cellular devices (respectively, devices that utilize cellular communication via a network) that have to communicate via cellular access points (e.g., eNB):

Capacity gain: First, radio resources (e.g. OFDM resource blocks) between the D2D and cellular layers may be reused (reuse gain). Second, a D2D link or sidelink uses a single hop (of radio transmission) between the transmitter and receiver points as opposed to the 2-hop link via a cellular AP (hop gain);

Peak rate gain: due to the proximity and potentially favorable propagation conditions, high peak rates could be achieved (proximity gain);

Latency gain: When the UEs communicate over a direct link, eNB forwarding is short cut and the end-to-end latency can decrease.

The introduction of D2D communication utilizing resources (time-frequency resources as well as device resources/circuitry) usually used for cellular communication thus is a promising approach, however, poses new challenges for developers.

### SUMMARY

It is an object of the present disclosure to provide approaches facilitating configuration of devices involved in D2D communication and/or associated network nodes.

Accordingly there is disclosed a method for operating a D2D device. The D2D device is adapted for D2D communication, and the method comprises transmitting a D2D coordination message to a second D2D device and/or a network node. Based on the D2D coordination message, configuration may be performed or facilitated.

The D2D coordination message may be transmitted to a network node serving the D2D device (serving node). A serving node is a suitable node for configuring the D2D device, and/or should be informed about a configuration of the D2D device. It may be considered that the D2D coordination message is based on a message received from another D2D device. In particular, the D2D coordination message may be a message relayed by the D2D device, from the other D2D device to the network node serving the D2D device.

Alternatively or additionally, a D2D coordination message may be transmitted to a second D2D device, which is an intended target for D2D communication. This allows direct coordination between the D2D devices, e.g. to set up D2D communication. Alternatively, the D2D coordination message transmitted by the D2D device may be based on a message received from a network node. In particular, the D2D coordination message may be a message relayed from the network node to the second D2D device.

The D2D coordination message may comprise a coordination request. This request message may in particular be transmitted and/or addressed to a network node, in particular a network node serving the D2D device.

The method may further comprise receiving a coordination response message from the second D2D device. The D2D coordination message may be in response to the D2D coordination message, which may comprise a request.

It may be considered that the D2D coordination message is a response to a received message, in particular a request message, which may in particular be received from another D2D device or a network node.

An independent method, or a further refinement of the described method, may comprise configuring the D2D device for D2D communication, in particular based on the D2D coordination message. Configuring based on the D2D coordination message may comprise configuring according to configuration parameters included in the coordination message and/or based on parameters the coordination message is based on and/or based on a response to the coordination message received by the D2D device.

Configuring may be based on a D2D configuration message. The D2D configuration message may be received from a network node or another D2D device, in particular in response to the D2D coordination message.

Alternatively, configuring may comprise configuring a second D2D for D2D communication, e.g. by transmitting a D2D configuration instruction message to the second D2D message.

The D2D coordination message and/or the D2D configuration message (and/or the D2D configuration instruction message) may pertain to a D2D mode and/or a transmission configuration, in particular a transmission mode configuration, and/or a reception configuration.

There is also disclosed a D2D device adapted for D2D communication, the D2D device being further adapted to perform any one or any combination of the methods for operating a D2D device disclosed herein. The D2D device may comprise a transmitting module for transmitting as described herein. It may be considered that the D2D device comprises a configuring module for configuring as described herein.

In addition, there is disclosed a method for operating a network node. The network node is adapted for coordinating a D2D device for D2D communication. The method comprises transmitting a network coordination message to a D2D device and/or a second network node. This allows setting up configuration of the D2D device for D2D communication. Coordinating a D2D device for D2D communication may generally comprise transmitting a network coordination message. The message may pertain to the D2D device to be coordinated. Coordinating a D2D device may refer to coordinating with the D2D device and/or regarding the D2D device, e.g. with another network node.

The network coordination message may comprise a request or a response to a request. This allows exchanging information and/or acknowledging information.

It may be considered that the network coordination message is transmitted in response to a received D2D coordination message. In this matter, two-sided information exchange or relay to a third device may be facilitated. It should be noted that it may be feasible to transmit the network coordination message to another network node or a second D2D device in response to the received D2D coordination message. The D2D coordination message may be transmitted by a D2D device as described herein.

An independent method, or a further refinement of the described method, may comprise transmitting a network configuration message to a second network node and/or a D2D device. The network configuration message may comprise a configuration and/or instruct a configuration to a D2D device, and/or inform the second network node about the configuration to be configured, e.g. to a D2D device and/or a second D2D device and/or a second network node.

There is also disclosed a network node for a wireless communication network. The network node may be adapted to perform any one or any combination of the methods for operating a network node described herein. Generally, the network node may be adapted for coordinating a D2D device for D2D communication. It may be considered that the network node comprises a configuration module for transmitting the network configuration message, and/or a coordination module for transmitting the network coordination message.

A program product comprising instructions causing control circuitry to perform and/or control any of one or any combination of the methods described herein when executed on the control circuitry is also proposed. The instructions may be executable by the control circuitry,

There may also be considered a storage medium storing a program product as described herein.

A network node serving a D2D device may be a network node providing a cellular communication link or cell to the D2D device, and/or providing a cell relative to which the D2D device is in-coverage, and/or allocating resources to the D2D device. Such a serving network node may in particular provide control signaling to the D2D device, e.g. for coordinating and/or configuring and/or controlling D2D communication.

Generally, another or second D2D device (which may in particular be the target of a message or a source of a received message) may be a target or partner, or intended target or partner, of D2D communication. It may be considered that the other or second D2D device is a receiving D2D device or RX device. The D2D device transmitting the coordination message described herein may be considered a transmitting D2D device or TX device. Transmitting and receiving in this context may pertain to intended D2D transmissions (as opposed to transmitting or receiving the coordination or configuration messages). In particular, any configured configuration for D2D communication may pertain to such intended D2D transmissions.

A coordination message may comprise information indicating one or more possible (or available or configurable or configured) configurations for D2D communication, and/or indicate a request to configure D2D communication, and/or comprise information indicating an intended target for D2D communication, in particular an intended receiver, and/or suggested a configuration or configuration scheme, e.g. for D2D communication respectively associated or involved D2D device/s. Generally, a coordination message may comprise capability information (of which information indicating the available configurations may be an example). It may be considered that a coordination message responds to, or acknowledges a request.

It may be considered that a D2D coordination message may generally be a message transmitted by a D2D device. A network coordination message may be a message transmitted by a network node. A network coordination message and a D2D coordination message may be considered examples of a coordination message. Configuring D2D communication may refer to configuring a D2D device and/or a second D2D device and/or a network node serving the D2D device and/or a network node serving the second D2D device for D2D communication. It may in particular be considered that configuring a D2D device for D2D communication comprises configuring a transmission and/or reception configuration for D2D communication.

Coordinating two D2D devices or two sides (each side corresponding to a D2D device and an associated serving network node, if present) for D2D communication may comprise and/or be aimed at configuring the two D2D devices with matching transmission and/or reception configurations, and/or at informing the devices of the two sides about the configuration used for D2D communication.

A configuration message may be a message configuring its target with a configuration. Configuring may generally refer to instructing a device (e.g., with the configuration message, to adapt the configuring configuration, which may be indicate and/or parametrized in the configuration message. A device may generally configure itself by adapting the configuration configured.

A configuration may in particular pertain to a transmission configuration, e.g. a transmission mode, and/or a reception configuration, and/or a D2D communication mode (e.g., mode 1 or 2), and/or a D2D communication target. A transmission or reception configuration generally may refer to transmission or reception, respectively, of D2D communication. Such a configuration may for example indicate a setup for radio circuitry and/or antenna circuitry to be used for the communication. A D2D configuration message may be a configuration message transmitted by a D2D device. A network configuration message may be a configuration message transmitted by a network node. A configuration scheme may generally indicate matching configurations for two D2D devices coordinated or configured for D2D communication with each other, e.g. a TX device and a RX device. Configuring may generally be configuring for possible or intended future D2D communication. In some variants, configuring may refer to reconfiguring, e.g. configuring a changed configuration for future D2D communication and/or replacing a current configuration, which may be or not be in use for D2D communication.

Transmitting a configuration message may be based on and/or comprise determining a configuration (a configuration indicated by the configuration message), e.g. based on a coordination message received. A device (D2D device or network node) transmitting, or adapted for transmitting, a configuration message may determine (or decide on), or be adapted to determine (or to decide on), the configuration.

### BRIEF DESCRIPTION OF THE DRAWINGS

The drawings are provided to illustrate concepts and approaches of the disclosure and are not intended as limitation. The drawings comprise:

FIG. 1, showing a flowchart for coordinating on D2D communication;

FIG. 2, showing another flowchart for coordinating on D2D communication;

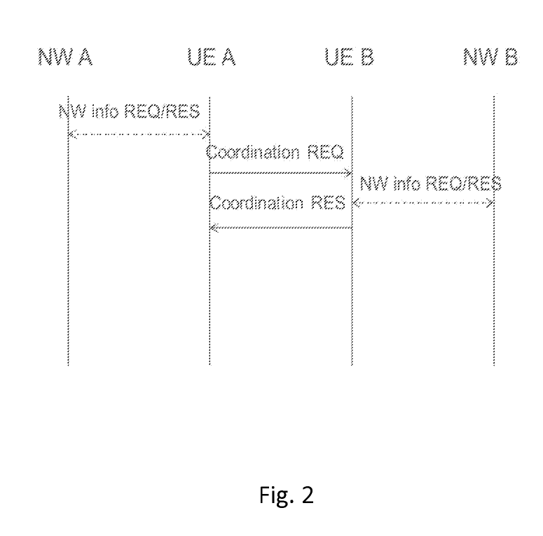

FIG. 3, showing a flowchart for configuring D2D communication;

FIG. 4, showing a flowchart for configuring D2D communication;

FIG. 5, showing a D2D network setup;

FIG. 6, schematically showing a D2D device; and

FIG. 7, schematically showing a network node.

### DETAILED DESCRIPTION

For LTE DL, different transmission modes (TM) are defined to address different MIMO (Multiple-Input, Multiple-Output, related to the use of multiple antenna elements) schemes and associated enablers.

Transmission Mode 1: Transmission from a single eNodeB antenna port;

Transmission Mode 2: Transmit diversity;

Transmission Mode 3: Open-loop spatial multiplexing;

Transmission Mode 4: Closed-loop spatial multiplexing;

Transmission Mode 5: Multi-User Multiple-Input Multiple-Output (MU-MIMO);

Transmission Mode 6: Closed-loop rank-1 pre-coding;

Transmission Mode 7: Transmission using UE-specific RSs with a single spatial layer;

Transmission Mode 8: Introduced in Release 9, transmission using UE-specific RSs with up to two spatial layers;

Transmission Mode 9: Introduced in Release 10, transmission using UE-specific RSs with up to eight spatial layers.

The transmission mode may be set according to a corresponding configuration.

To enable this, one key component in LTE is the formats for Downlink Control Information (DCI). The required content of the control channel messages (the DCI messages) depends on the system deployment and UE configuration. For example, if the infrastructure does not support MIMO, or if a UE is configured in a transmission mode which does not involve MIMO, there is no need to signal the parameters that are only required for MIMO transmissions. In order to minimize the signaling overhead, it is therefore desirable that several different message formats are available, each containing the minimum payload required for a particular scenario. On the other hand, to avoid too much complexity in implementation and testing, it is desirable not to specify too many formats. The set of DCI message formats in Table 9.2 is specified in LTE; Format 2B was added in Release 9, and Formats 2C and 4 were added in Release 10.

TABLE 1
DCI format definition for different transmission mode

| | | Applicable |
|---|---|---|
| | | PDSCH |
| DCI | | transmission |
| format | Purpose | mode(s) |
| 0 | PUSCH grants | All |
| 1 | PDSCH assignments with a single codeword | 1, 2, 7 |
| 1A | PDSCH assignments using a compact format | All |
| 1B | PDSCH assignments for rank-1 transmission | 6 |
| 1C | PDSCH assignments using a very compact format | n/a |
| 1D | PDSCH assignments for multi-user MIMO | 5 |
| 2 | PDSCH assignments for closed-loop MIMO | 4 |
| | operation | |
| 2A | PDSCH assignments for open-loop MIMO | 3 |
| | operation | |
| 2B | PDSCH assignments for dual-layer beamforming | 8 |
| 2C | PDSCH assignments for up to 8-layer spatial | 9 |
| | multiplexing | |
| 3 | Transmit Power Control (TPC) commands for | n/a |
| | multiple users for PUCCH and PUSCH with 2-bit | |
| | power adjustments | |
| 3A | Transmit Power Control (TPC) commands for | n/a |
| | multiple users for PUCCH and PUSCH with 1-bit | |
| | power adjustments | |
| 4 | PUSCH grants for up to 4-layer spatial | All (if |
| | multiplexing | configured |
| | | for PUSCH |
| | | transmission |
| | | mode 2) |

In the current LTE system, the TM is configured by RRC signaling. The IEs (information Elements) AntennalnfoCommon and AntennalnfoDedicated are used to specify the common and the UE specific antenna configuration respectively.

-- ASN1START

| | |
|---|---|
| AntennaInfoCommon ::= | SEQUENCE { |

| | |
|---|---|
| antennaPortsCount | ENUMERATED {an1, an2, an4, spare1} |

}

| | |
|---|---|
| AntennaInfoDedicated ::= | SEQUENCE { |

| transmissionMode | ENUMERATED { |
|---|---|
| | tm1, tm2, tm3, tm4, tm5, tm6, |
| | tm7, tm8-v920}, |
| codebookSubsetRestriction | CHOICE { |

| | |
|---|---|
| n2TxAntenna-tm3 | BIT STRING (SIZE (2)), |
| n4TxAntenna-tm3 | BIT STRING (SIZE (4)), |
| n2TxAntenna-tm4 | BIT STRING (SIZE (6)), |
| n4TxAntenna-tm4 | BIT STRING (SIZE (64)), |
| n2TxAntenna-tm5 | BIT STRING (SIZE (4)), |
| n4TxAntenna-tm5 | BIT STRING (SIZE (16)), |
| n2TxAntenna-tm6 | BIT STRING (SIZE (4)), |
| n4TxAntenna-tm6 | BIT STRING (SIZE (16)) |

| | | |
|---|---|---|
| } | OPTIONAL, | -- Cond |

TM

| | |
|---|---|
| ue-TransmitAntennaSelection | CHOICE{ |

| | |
|---|---|
| release | NULL, |

| | |
|---|---|
| setup | ENUMERATED {closedLoop, openLoop} |

}

}

| | |
|---|---|
| AntennaInfoDedicated-v920 ::= | SEQUENCE { |

| | |
|---|---|
| codebookSubsetRestriction-v920 | CHOICE { |

| | |
|---|---|
| n2TxAntenna-tm8-r9 | BIT STRING (SIZE (6)), |
| n4TxAntenna-tm8-r9 | BIT STRING (SIZE (32)) |

| | | |
|---|---|---|
| } | OPTIONAL | -- Cond |

TM8
}

| | |
|---|---|
| AntennaInfoDedicated-r10 ::= | SEQUENCE{ |

| | |
|---|---|
| transmissionMode-r10 | ENUMERATED { |

tm1, tm2, tm3, tm4, tm5, tm6, tm7, tm8-v920,
tm9-v1020, tm10-v1130, spare6, spare5,

spare4,

| | spare3, spare2, spare1}, | | |
|---|---|---|---|
| codebookSubsetRestriction-r10 | BIT STRING | OPTIONAL, | -- |

Cond TMX

| | |
|---|---|
| ue-TransmitAntennaSelection | CHOICE{ |

| | |
|---|---|
| release | NULL, |

| | |
|---|---|
| setup | ENUMERATED {closedLoop, openLoop} |

}

}
-- ASN1STOP

A D2D device like a UE (at least in LTE) can operate in two modes for resource allocation:

Mode 1: eNodeB or Release-10 relay node schedules the exact resources used by a UE to transmit direct data and direct control information. A semi-static resource pool restricting the available resources for data and/or control may be considered.

Mode 2: a UE on its own selects resources from resource pools to transmit direct data and direct control information. It may be considered that the resource pools for data and control are the same, or different. A semi-static and/or pre-configured resource pool restricting the available resources for data and/or control may be utilised.

A D2D communication capable UE (D2D device) may support at least Mode 1 for in-coverage.

A D2D communication capable UE may support Mode 2 for at least edge-of-coverage and/or out-of-coverage.

Generally, a D2D device or UE may be considered in-coverage if it has a serving cell (CONNECTED) or is camping on a cell (IDLE). The terms CONNECTED and IDLE may be considered to refer to RRC states according to LTE.

If a UE is out of coverage, it may only be able to use mode 2 (direct mode). If a UE is in-coverage, it may use mode 2, in particular if the eNB configures it accordingly. If a UE is in-coverage, it may use mode 1, in particular if the eNB configures it accordingly. If the UE is instructed or configured to use mode 1, there may be exceptional cases where the UE is allowed to use mode 2 temporarily, (e.g. if UE fails to establish an RRC connection, etc.). Such criteria may be predetermined (e.g., by a standard/LTE), and/or configured, e.g. by a network node.

Exceptional cases may be defined rather than, and/or including versions of, an edge-of-coverage “state”.

The present disclosure is related to configuration of D2D devices and/or network nodes in the context of D2D communication, in particular for transmission mode configuration, but not limited to it. The approaches disclosed herein may be applied to general configuration of the ProSe link (sidelink) that may relate to/require coordination of the two D2D devices.

In R12, the scenario is only limited to broadcast communication, i.e., no explicit association between Tx (transmitter) and Rx (receiver), so the Tx transmission is open to be received by all Rx(s). The configuration operation in this context may need only to consider the capability/status of Tx UE and its serving eNB. Extending to unicast and multicast (e.g., targeted and/or addressed transmissions) may require feedback from Rx (a different feedback mode may be introduced). In this context, there would be dedicated (addressed) Rx(s) for a Tx. The corresponding transmission mode configuration may take the capability/status of the associated Rx(s) and/or its serving eNB into account as well. The configuration may be required to reach/be known by both Tx and Rx UE and/or the associated serving eNBs.

The following methods (although the wording assumes that the NW (short for Network) entities serving the two UEs are separated, it can be applied to the scenario where both UEs are served by the same entity) are described. The involved devices may be adapted to perform the associated actions. In the following, the term UE is used to indicate an exemplary D2D device, in particular a D2D device according to LTE. The term D2D device may be used interchangeably to UE.

In the following figures, UE A/UE B represent Tx/Rx UE respectively, and NW A/B are the serving NW entities for the two UEs respectively. For example, in a solution on the RAN level, the NW entities may be network nodes like eNodeBs. Thus, the two UEs may be in different cells for cellular communication. For non-RAN solutions, the NW entities can represent for example the ProSe-Functionality, in which case the two UEs can be in different PLMNs (Public Land Mobile Network).

For the case in which the two UEs are served by a same NW entity, the inter-entity communication signaling can be omitted.

For the case in which one or both UEs are out of coverage (OoC), part of the signaling that relates to the NW entity (which is indicated as optional) can be omitted.

A first method aiming at coordination before configuration operation is suggested.

This method allows either the NW entities or UEs (or both) to reach an agreement on an (or a set of) allowed configuration/s for the D2D communication between the two UEs.

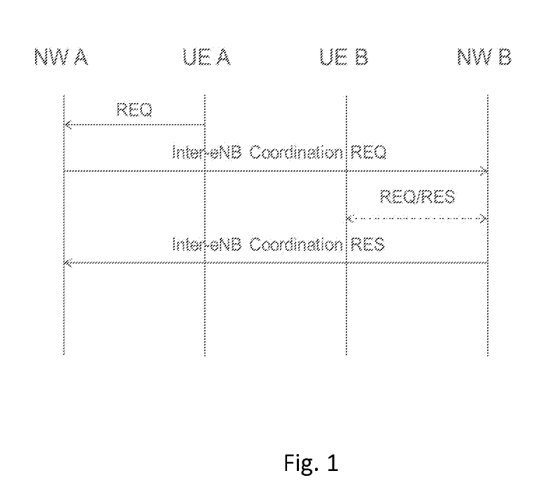

Embodiment 1A shows coordination between NW entities as illustrated in FIG. 1.

Action 1: UE A may signal to NW A to start the configuration operation, e.g. with a coordination message indicating a corresponding request REQ, which may include at least the ID of UE B who is communicating or intended to communicate with UE A. This signaling can be carried in different ways, e.g., by RAN message like MAC CE message or RRC signaling, or by higher layer message like PC3 signaling or application layer message.

Action 2: In this action, NW entity A triggers the coordination with NW entity B using a signaling via an inter-entity interface, e.g., via either X2/S1 (depending whether X2 interface is available to carry the signaling) as RAN solution, or PC6 interface as non-RAN solution. The coordination may include transmission of a network coordination message (Inter-eNB Coordination REQ), which may include:

the ID of UE B; and/or

the suggested Configuration/s or Configuration scheme(s)for the D2D communication between the two UEs; and/or

context information (or only the ProSe/D2D part) of UE A for NW entity B reference. 1)

Action 3 (optional): In this action, NW entity B transmits a network coordination message with a request to get some capability information from UE B, which may be not available at NW entity B, yet necessary to make a decision on configuration. This could be in a capability enquiry procedure or a reconfiguration procedure.

Action 4: In this action, NW entity B responds to NW entity A, on the preferred Configuration scheme(s), which may be based on a response to the message send to UE B in action 3. The response to NW entity A may include the context (or only the ProSe part) of UE B for NW entity A reference.

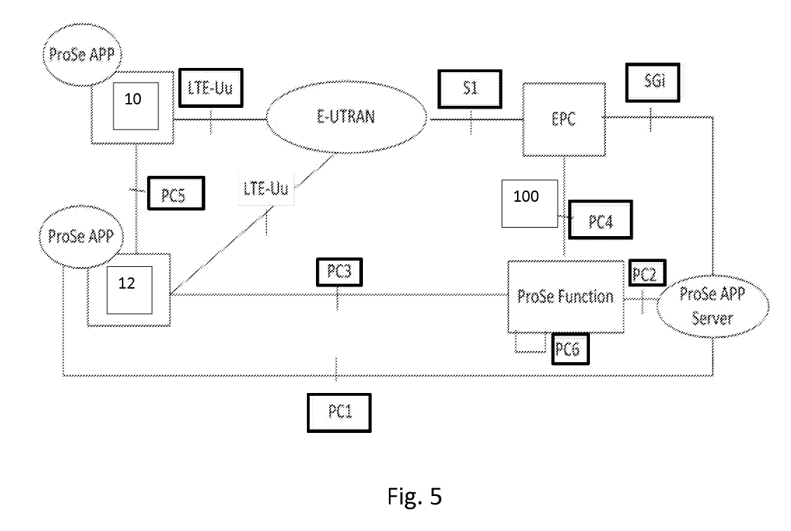

Embodiment 1B shows coordination via the PC5 interface (direct interface between the UEs, see FIG. 5)

Action 1 (optional): In this action, UE A enquires/requests from the NW entity A information which is needed for a configuration scheme selection, which can be

1) either just reading broadcast system information pertaining to the TM configuration (e.g., allowed mode in the coverage of NW entity A);

2) or dedicated signaling exchange between NW entity A and UE A pertaining to configuration info.

Action 2: In this action, the UE A triggers the coordination between the two UEs via signaling on PC5 directly, utilising a D2D coordination message. The message may be transmitted e.g. as a ProSe discovery message or a ProSe communication message (ProSe may be interchanged with D2D in this context).

The content of this signaling (the message) can include

the suggested configurations or configuration scheme(s);

the supported configuration/s or configuration scheme(s) according to the capability of UE A.

Action 3 (optional): In this action, similar to action 1, the UE B may enquire/request from NW entity B information needed for configuration scheme selection.

Action 4: In this step, UE B responds to UE A on the preferred configuration scheme(s). The corresponding signaling may for example comprise a ProSe discovery message, or a ProSe communication message.

A configuration method is disclosed in the following. The configuration method may be performed independently of the coordinating method, or be based on or performed after a coordinating method. The entities and devices described may be adapted to perform the associated actions.

The two UEs (or the respective sides, which may including the two NW entities) decide on a single/same configuration scheme. For simplifying the decision, one of the UEs (or NW entity) may act as “Master” and decides which configuration to use.

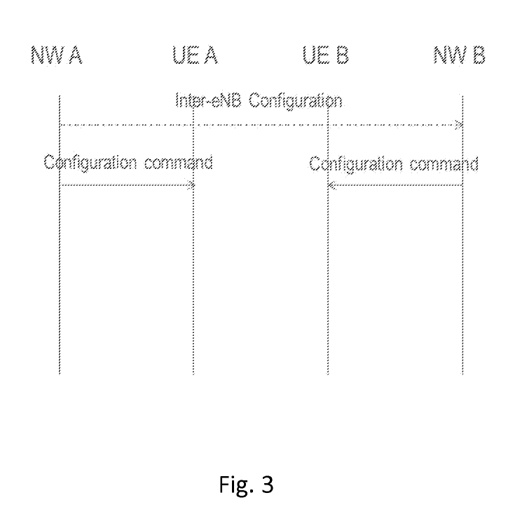

Embodiment 2A pertains to NW configuration shown in FIG. 3.

Action 0 (optional): In this action, signaling between the two NW entities is used to select a signal configuration for the ProSe communication. For this embodiment, typically NW entity A acts as the “Master” and decides which configuration to use. It may indicate this configuration, e.g. in a network configuration message (referred to as Inter-eNB Configuration in FIG. 3, to the NW entity B.

Some similarity exist between this signaling and action 2/4 in embodiment 1A, so that it is possible they can actually reuse the same signaling, e.g., the coordination is done in a way to reach a single (not a set of) Configuration scheme, which would be later used directly for the two Ues.

Action 1: A directly signaling utilizing a network configuration message (Configuration command) from NW A to UE A and NW B to UE B to indicate the configuration to be applied by the two UEs for ProSe/D2D communication. The messages may respectively be transmitted e.g. using the Uu interface in a RAN solution, or using PC3 interface in a non-RAN solution.

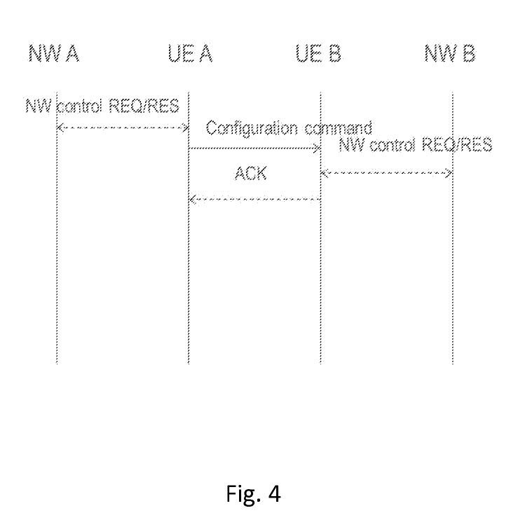

Embodiment 2B pertains to UE configuration as shown in FIG. 4.

Action 1 (optional): In this action, UE A enquires, or requests, from the NW entity A information regarding the configuration scheme decision, e.g. utilising a D2D coordination message including the request. The NW entity A has the chance to override the suggestion from UE A (if any is indicated in the request/message), to ensure the NW control on configuration. A corresponding response may be transmitted to the UE A from the NW entity A.

Action 2: In this action, the UE A sends a configuration command (representing a D2D configuration message) to the UE B, for example utilising PHY control channel signaling or MAC control element signaling or RRC signaling (and/or utilising D2D transmission).

From a PC5 point of view, UE A is the “Master” in this embodiment.

Action 3 (optional): In this action, the UE B enquires or request from NW entity B information regarding the configuration scheme decision, e.g. utilising a D2D coordination message including the request. The NW entity B may have the chance to override a configuration suggestion from UE A and/or UE B with a corresponding response, to ensure the NW control on configuration.

Action 4 (optional): In this action, a feedback or response or acknowledgment message ACK may be transmitted from the UE B to UE A, in order for UE A to know whether the configuration command is received by UE B correctly, and/or whether the UE B (and its serving NW entity) accepts this configuration nor not. The acknowledgment message may comprise corresponding information.

Which coordination scheme (1A, 2A) and configuration scheme (1B, 2B) is to be chosen may be dependent on the coverage state of the Tx and/or Rx devices (UEs). Specifically, since 1A and 1B requires NW entity related signaling, it can be applied in InC (In coverage) scenarios, while 2A and 2B can be applied to OoC (out-of-coverage) scenarios.

It may be also be dependent on the RRC state of the Tx and/or Rx devices. Specifically, since 1A and 1B may require NW entity related signaling, it can be applied to RRC connected UE scenarios, while 2A and 2B can be applied to RRC idle UE scenarios.

It can be dependent on the release (standard release) the TX and/or RX devices are adapted for, and/or on the capabilities of the Tx and/or Rx devices, if assumed that 1A/2A/1B/2B are supported by different releases or UE category.

As mentioned above, one of the NW entities and/or UEs may act as the “Master” and selects the configuration. Typically this is the UE which initiates the unicast communication session, or the NW entity which controls this UE. In particular, it may be the device transmitting the configuration message, be it a network configuration message or a D2D configuration message.

An exemplary reference architecture for D2D operation according to one possible LTE/E-UTRAN implementation is illustrated in FIG. 5, in which only a setup with two UEs 10, 12 connected to a common base station or eNodeB 100 is shown. In FIG. 4, PCn identifies different reference points or interfaces. PC1 refers to a reference point between a ProSe application ProSe APP running on an D2D device or UE 10 or 12, PC2 a reference point between an ProSe Application server and a ProSe function provider on a server or base station side. PC3 indicates a reference point between the D2D device or UE 12 and the ProSE function, e.g. for discovery and/or communication. PC4 refers to a reference point between the EPC and the ProSe function, e.g. for setting up setting up one-to-one communication between UEs 10 and 12. PC5 is a reference point or interface between D2D device or UE 10 and D2D device or UE 12, e.g. a first node and a second node involved in D2D communication, which may be used e.g. for direct or relayed communication between the UEs. PC6 identifies a reference point between ProSE functions of different networks, e.g. if UEs 10, 12 are subscribed to different PLMNs (Public Land Mobile Networks). SGi indicates an interface which may be used, inter alia, for application data and/or application level control. The EPC (Evolved Packet Core) may generally include a plurality of core packet functions or entities, e.g. MME, SGW, PWG, PCRF (Policy Charging and Rules Function), HSS (Home Subscriber Server), etc. E-UTRAN is the preferred RAT of the arrangement of FIG. 4. LTE-Uu indicates data transmission connections between the UEs 10, 12 and the base station 100.

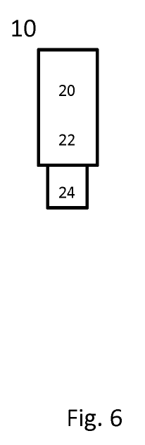

FIG. 6 schematically shows a D2D device 10, which may in particular be implemented as a user equipment. D2D device 10 comprises control circuitry 20, which may comprise a controller connected to a memory. Receiving node 10 also comprises radio circuitry 22 providing receiving and transmitting or transceiving functionality, the radio circuitry 22 connected or connectable to the control circuitry. An antenna circuitry 24 of the D2D device 10 is connected or connectable to the radio circuitry 22 to collect or send and/or amplify signals. Radio circuitry 22 and the control circuitry 20 controlling it are configured for cellular communication with a network, in particular a base station. The D2D device 10 may be adapted to carry out any of the methods for operating a D2D device disclosed herein; in particular, it may comprise corresponding circuitry, e.g. control circuitry. Modules of the D2D device may be implemented in the circuitry of the D2D device.

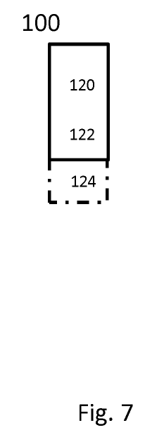

FIG. 7 schematically show an example of a network node 100, which in particular may be a base station or eNodeB (also referred to as eNB herein). Network node 100 comprises control circuitry 120, which may comprise a controller connected to a memory. The control circuitry 120 is operably connected to control radio circuitry 122 of the network node 100, which provides receiver and transmitter and/or transceiver functionality. An antenna circuitry 124 may be connected or connectable to radio circuitry 122 for signal reception or transmittance and/or amplification. The network node 100 may be adapted to carry out any of the methods for operating a network node disclosed herein; in particular, it may comprise corresponding circuitry, e.g. control circuitry. Modules of the network node may be implemented in the circuitry of the network node.

A message may generally comprise one or more signals and/or symbols. A message may be comprise a self-contained block of information, which may be separated in different parts, which may comprise e.g. a header part and a data part, etc. A message may be in a prescribed format, e.g. according to a standard like LTE.

Generally, a D2D device may be a wireless device or terminal enabled for D2D operation. A D2D device may be implemented as a user equipment (UE). Information transmitted in D2D communication may comprise data (e.g., user data) and/or control data, the latter of which may pertain to the D2D operation itself. A D2D device may generally be adapted for cellular communication and D2D communication. A D2D device may for example be implemented a mobile phone, smartphone, tablet, laptop, or any other kind of device capable of D2D communication.

A D2D message transmitted from one D2D device to another D2D device may be a message transmitted utilizing D2D communication, e.g. mode 1 or mode 2. A D2D coordination message and/or D2D configuration message transmitted to a second D2D device may be D2D messages, in particular representing control data. However, a D2D coordination message or a D2D configuration message transmitted by a D2D device may also utilize a cellular transmission mode, depending on the setup and use case. In particular if the D2D message is transmitted to a network node, it may utilize cellular transmission.

D2D communication may generally comprise transmitting and/or receiving D2D messages or signaling, in particular over a D2D air interface. The D2D communication may pertain to D2D signaling, which may comprise data and/or control data. D2D communication may comprise discovery signaling. D2D communication may generally require resources available for cellular communication, respectively require sharing those resources. In particular, D2D communication may generally be performed using frequency resources of cellular communication. D2D communication may in particular comprise D2D communication according to mode 1 or mode 2. Mode 1 generally may be facilitated by a network node, which in particular may allocate resources for the mode 1 D2D communication, for example specifically, or in a resource pool. Mode 1 D2D communication may generally comprise communication between the D2D device and the network node regarding use of resources, in particular the D2D device may inform the network node about resources intended to be used for D2D communication, and/or request such from the network node. Mode 2 D2D communication may generally be performed without such resource-related communication from the D2D device to the network node. The network node in this context may be a network node serving the D2D device.

A message pertaining to a configuration or mode may comprise information and/or a parametrization and/or one or more instructions regarding the configuration and/or to configure the configuration.

A D2D device or network node may comprise control circuitry, which may be adapted for control functionality, in particular for controlling and/or carrying out the respective method/s described herein.

Control circuitry may generally comprise integrated circuitry, and/or one or more controller/s and/or microcontroller/s and/or processor/s and/or processor core/s and/or ASIC (Application Specific Integrated Circuitry) and/or FPGA/s (Field-Programmable Gate Array/s). Control circuitry may operably comprise and/or be connected or connectable to one or more memory devices, e.g. magnetic or optical memory, flash memory, buffer memory, cache memory, RAM (Random Access Memory), ROM (Read-Only Memory) and/or a storage medium as described herein.

A storage medium may comprise any one or any combination of the memories as described herein, and/or may be readable by control circuitry, e.g. via a corresponding Input/Output interface.

A network node (sometimes also referred to as network entity) may generally be a radio network node like a base station or relay node or micro node (or pico or femto or macro node), in particular an eNodeB.

It may be considered that a network node or D2D device comprises radio circuitry, which may be adapted to provide transmitting and/or receiving and/or transceiving functionality, and/or filtering and/or amplifying and/or detection and/or measuring functionality. The control circuitry may be operably connected to control the radio circuitry. A network node or D2D device may comprise, and/or be connected or connectable to, antenna circuitry, which may comprise one or more antenna elements and/or antenna arrangements for wireless or radio transmission or reception. Any of the modules of a network node or D2D device, in particular a transmitting module and/or configuration module and/or coordination module may be implemented with firmware and/or hardware and/or software on or in such circuitry.

Cellular communication may generally utilize a Radio Access Network (RAN), e.g. according to a standard like LTE, in which case the RAN is referred to as E-UTRAN. A non-RAN-solution may generally refer to higher network layers situated in a core network connected to the RAN.

A context of a D2D device or UE may generally describe operation conditions (one or more thereof) of the D2D device, internal and/or external conditions. A context may generally comprise information representing or indicating such condition/s. Internal conditions may pertain or represent to capabilities of the D2D device (in particular, transmission, reception and/or format capabilities, the latter of which may e.g. comprise standard compatibility). External conditions may comprise location and/or cell neighborhood, e.g. number of cells, signal strength, etc, whether the D2D device is at a cell edge, handover status, movement status of the D2D device, signaling environment (e.g., presence of strong interference, and/or signal-to-noise), location in relation to one or more network nodes or network node density, coverage situation, presence of legacy networks in a vicinity, etc.

In this description, for purposes of explanation and not limitation, specific details are set forth (such as particular network functions, processes and signaling steps) in order to provide a thorough understanding of the technique presented herein. It will be apparent to one skilled in the art that the present concepts and aspects may be practiced in other embodiments and variants that depart from these specific details.

For example, the concepts and variants are partially described in the context of Long Term Evolution (LTE) or LTE-Advanced (LTE-A) or Next Radio mobile or wireless communications technologies; however, this does not rule out the use of the present concepts and aspects in connection with additional or alternative mobile communication technologies such as the Global System for Mobile Communications (GSM). While the following embodiments will partially be described with respect to certain Technical Specifications (TSs) of the Third Generation Partnership Project (3GPP), it will be appreciated that the present concepts and aspects could also be realized in connection with different Performance Management (PM) specifications.

Moreover, those skilled in the art will appreciate that the services, functions and steps explained herein may be implemented using software functioning in conjunction with a programmed microprocessor, or using an Application Specific Integrated Circuit (ASIC), a Digital Signal Processor (DSP), a Field Programmable Gate Array (FPGA) or general purpose computer. It will also be appreciated that while the embodiments described herein are elucidated in the context of methods and devices, the concepts and aspects presented herein may also be embodied in a program product as well as in a system comprising control circuitry, e.g. a computer processor and a memory coupled to the processor, wherein the memory is encoded with one or more programs or program products that execute the services, functions and steps disclosed herein.

It is believed that the advantages of the aspects and variants presented herein will be fully understood from the foregoing description, and it will be apparent that various changes may be made in the form, constructions and arrangement of the exemplary aspects thereof without departing from the scope of the concepts and aspects described herein or without sacrificing all of its advantageous effects. Because the aspects presented herein can be varied in many ways, it will be recognized that any scope of protection should be defined by the scope of the claims that follow without being limited by the description.

1.-18. (canceled)

19. A method for operating a D2D device, the D2D device being adapted for D2D communication, the method comprising transmitting a D2D coordination message to a second D2D device and/or a network node.

20. The method according to claim 19, the D2D coordination message being transmitted to a network node serving the D2D device.

21. The method according to claim 19, the D2D coordination message being transmitted to a second D2D device which is an intended target for D2D communication.

22. The method according to claim 19, wherein the D2D coordination message comprises a coordination request.

23. The method according to claim 21, further comprising receiving a coordination response message from the second D2D device.

24. The method according to claim 19, wherein the D2D coordination message is transmitted in response to a received message.

25. The method according to claim 19, the method further comprising configuring the D2D device for D2D communication based on the D2D coordination message.

26. The method according to claim 25, wherein configuring is based on a D2D configuration message received from a network node or another D2D device.

27. The method according to claim 25, wherein configuring further comprises configuring a second D2D device for D2D communication.

28. The method according to claim 19, wherein the D2D coordination message and/or the D2D configuration message pertains to at least one of the following: a D2D mode, and a transmission mode configuration.

29. A method for operating a network node, the network node being adapted for coordinating a D2D device for D2D communication, the method comprising transmitting a network coordination message to at least one of the following: a D2D device, and a second network node.

30. The method according to claim 29, wherein the network coordination message comprises either a request or a response to a request.

31. The method according to claim 29, wherein the network coordination message is transmitted in response to a received D2D coordination message.

32. The method according to claim 29, wherein the method comprises transmitting a network configuration message to a second network node and/or a second D2D device.

33. D2D device configured for operation in a wireless communication network, the D2D device comprising radio circuitry and control circuitry operably connected and configured to perform operations corresponding to the method of claim 19.

34. Network node configured for operation in a wireless communication network, the network node comprising radio circuitry and control circuitry operably connected and configured to perform operations corresponding to the method of claim 29.

35. Non-transitory, computer-readable medium storing computer-executable instructions that, when executed by control circuitry comprising a D2D device, configure the D2D device to perform operations corresponding to the method of claim 19.

36. Non-transitory, computer-readable medium storing computer-executable instructions that, when executed by control circuitry comprising a network node, configure the network node to perform operations corresponding to the method of claim 29.
